(19) United States
(12) Patent Application Publication
(10) Pub. No.: US 2016/0210174 A1
(43) Pub. Date: Jul. 21, 2016

(54) Hybrid Scheduler and Power Manager

(71) Applicant: Microsoft Corporation, Redmond, WA (US)

(72) Inventors: Bor-Ming Hsieh, Redmond, WA (US); Glenn F. Evans, Kirkland, WA (US); Neeraj Singh, Seattle, WA (US); Abhishek Sagar, Redmond, WA (US)

(73) Assignee: MICROSOFT CORPORATION, Redmond, WA (US)

(21) Appl. No.: 14/598,156

(22) Filed: Jan. 15, 2015

(51) Int. Cl. G06F 9/50

(52) U.S. Cl. CPC G06F 9/5038

(57) ABSTRACT

In one example, a processor may schedule a processing thread for execution based on a dynamic scheduling priority. A memory may associate a scheduling priority with a processing thread. A scheduler may adjust the scheduling priority based on a time frame. The scheduler may set a processing schedule for execution of the processing thread based on a scheduling parameter set including the scheduling priority. At least one processing core may execute the processing thread based on the processing schedule.

### BACKGROUND

A computing device may perform multiple tasks in a seemingly simultaneous manner. The computing device may have multiple processing cores and each may execute a series of processing tasks, referred to as processing threads. A single processing core may execute multiple processing threads by interleaving the different tasks of each processing thread, with each task accomplished in a fraction of a second. A scheduler may decide which task is being performed by which processing core at any given time.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Examples discussed below relate to scheduling a processing thread for execution based on a dynamic scheduling priority. A memory may be configured to associate a scheduling priority with a processing thread. A scheduler may be configured to adjust the scheduling priority based on a time frame. The scheduler may be configured to set a processing schedule for execution of the processing thread based on a scheduling parameter set including the scheduling priority. At least one processing core may be configured to execute the processing thread based on the processing schedule.

### DRAWINGS

In order to describe the manner in which the above-recited and other advantages and features can be obtained, a more particular description is set forth and will be rendered by reference to specific examples thereof which are illustrated in the appended drawings. Understanding that these drawings depict only typical examples and are not therefore to be considered to be limiting of its scope, implementations will be described and explained with additional specificity and detail through the use of the accompanying drawings.

FIG. 1 illustrates, in a block diagram, one example of a set of processing threads.

FIG. 2 illustrates, in a block diagram, one example of a computing device.

FIG. 3 illustrates, in a block diagram, one example of a processing system.

FIG. 4 illustrates, in a block diagram, one example of a data output queue.

FIG. 5 illustrates, in a block diagram, one example of a thread profile.

FIG. 6 illustrates, in a flowchart, one example of a method of developing a thread profile.

FIG. 7 illustrates, in a flowchart, one example of a method of scheduling a processing thread.

FIG. 8 illustrates, in a flowchart, one example of a method of managing a processing core set.

FIG. 9 illustrates, in a flowchart, one example of a method of processing a processing thread.

### DETAILED DESCRIPTION

Examples are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a machine-implemented method, a tangible machine-readable medium having a set of instructions detailing a method stored thereon for at least one processor, or a processing system for a computing device.

A scheduler may assign various processing threads to one or more processing cores. A processing core may be a hardware processing core or a virtual processing core acting as an abstraction of one or more hardware processing cores. The scheduler may dynamically alter or migrate the processing threads between processing cores based on the characteristics or metadata of the work being performed. The processing core may execute the tasks of a processing thread according to a processing schedule. The scheduler may set the processing schedule based on a set of scheduling parameters, such as a scheduling priority or a scheduling deadline. A scheduling priority describes the order of preference between multiple threads in regards to processing resources. A scheduling deadline may describe the time by which a processing thread is to be processed. The scheduling deadline may be absolute in time or relative to a reference point, such as initiation of the processing thread.

The processing schedule may have the processing core favor one processing thread over another based on a scheduling priority. The scheduler may postpone or move a processing task to allow the processing core to process a higher priority task. For example, an audio data thread, which may show a failure to process caused by the processing core running behind schedule, may have precedence over a background task, such as an anti-virus program. However, the processing schedule may have safeguards in place to prevent a high priority processing thread from completely taking over a processing core, thereby allowing a lower priority task to achieve some forward progress. For example, if a processing core has spent 80% of its processing time on an audio processing thread, a background diagnostic thread task may be inserted into the processing schedule before some of the audio processing thread tasks.

The scheduler may take advantage of various work characteristics of a processing thread, such as time or priority. For example, once a processing core executing an audio processing thread has filled an audio buffer with audio data, the scheduling priority of the audio processing thread may be downgraded to allow other processing threads to take precedence. Once the audio buffer has been emptied, the audio processing buffer may assume the original higher scheduling priority. Further, as a deadline approaches, the scheduler may gradually increase the scheduling priority for the processing thread.

Additionally, a power manager may use this deadline cognizant scheduling to better manage processing resources. The power manager may determine an optimal arrangement of active processing cores and processing core frequencies for a corresponding workload. As a scheduling deadline approaches, the power manager may activate more processing cores or gradually increase the processing frequency of the processing core to better guarantee that the processing threads are properly executed prior to the scheduling deadline. A processing frequency is the frequency of performing a task by the processing core. Once the scheduling deadline has passed, the power manager may then take processing cores offline or gradually decrease the processing frequency of the processing core as appropriate to save power.

A processing system may use a thread metadata tag to track the processing of these processing threads to improve the scheduling and power management. For example, a thread metadata tag may indicate that a processing thread is a video processing thread. Armed with this knowledge, the scheduler and power manager may make scheduling and resource decisions optimized to execute a video processing thread. The scheduler may use a thread metadata tag to track the work associated with a processing thread as the processing thread moves to a different processing core. The scheduler may apply separate performance policies on a processing core executing tagged work as opposed to a processing core not executing tagged work. Further, the processing system may use the thread metadata tags to build a thread profile, describing optimum scheduling priorities and scheduling deadlines for a processing thread that matches a thread classification described in the thread metadata tag. A thread classification indicates the type of work that the processing thread executes. The thread profile may also take into account the form factor of the computing device when determining a scheduling priority and a scheduling deadline for that processing thread.

Thus, in one example, a processor may schedule a processing thread for execution based on a dynamic scheduling priority. A memory may be configured to associate a processing thread with a thread metadata tag describing a thread classification for the processing thread. A scheduler may be configured to set a scheduling priority for the processing thread based on a thread profile associated with the thread metadata tag. The memory may be configured to associate the processing thread with the scheduling priority. The scheduler may be configured to adjust the scheduling priority based on a time frame. The scheduler may be configured to set a processing schedule for execution of the processing thread based on a scheduling parameter set including the scheduling priority. The power manager may be configured to select an active processing core subset from a processing core set based on a scheduling parameter set including a scheduling deadline for the processing thread. The power manager may be configured to activate the active processing core subset. The active processing core subset may be configured to execute a processing schedule based on the scheduling parameter set for the processing thread. The active processing core subset may be configured to execute the processing thread based on the processing schedule.

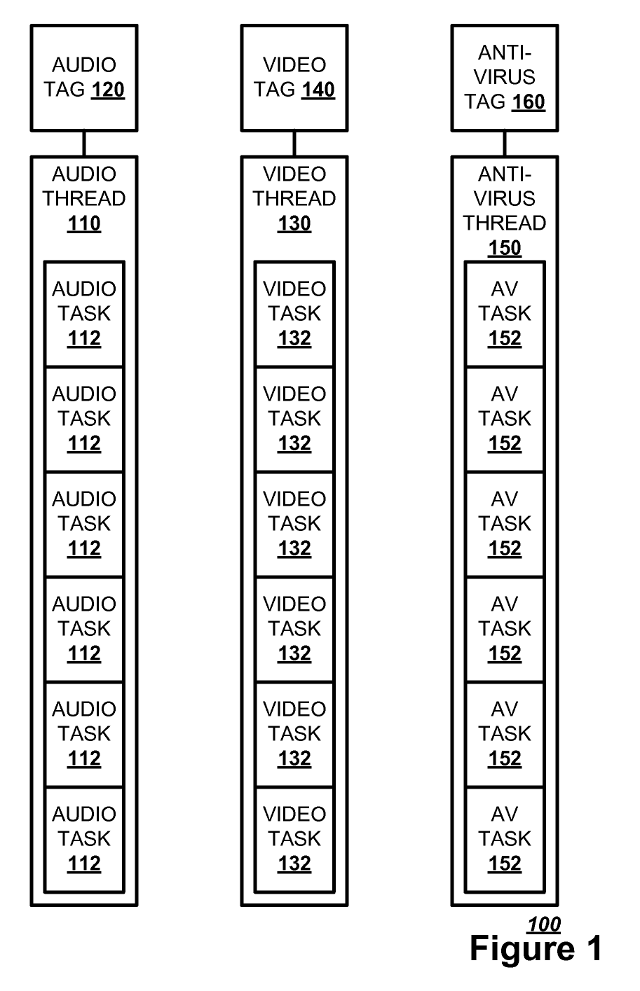

FIG. 1 illustrates, in a block diagram, one example of a set 100 of processing threads. A processing thread may be grouped according to one or more thread classifications, with a thread metadata tag describing the thread classification. A thread metadata tag may be affixed to a processing thread. Alternately, the thread metadata tag may be applied to a software module, such as a subroutine. Any processing thread that invoked such software modules may be implicitly associated with the thread metadata tag.

The thread classification indicates the type of work that the processing thread executes. For example, a processing thread may be an audio thread 110 that performs a set of one or more audio tasks 112. The audio thread 110 may be tagged with an audio metadata tag 120. The audio metadata tag 120 may indicate that the processing thread is providing audio data to be given a high priority, so that the audio thread 110 is processed first to avoid glitches. Alternately, a processing thread may be a video thread 130 that performs a set of one or more video tasks 132. The video thread 130 may be tagged with a video metadata tag 140. The video metadata tag 140 may indicate that the processing thread is providing video data to be given the next highest priority, so that the video thread 130 is processed after the audio thread 110, but before other processing threads. Further, a processing thread may be an anti-virus thread 150 that performs a set of one or more anti-virus tasks 152. The anti-virus thread 150 may be tagged with an anti-virus metadata tag 160. The anti-virus metadata tag 160 may indicate that the processing thread is performing anti-virus functions to be given the lowest priority, so that the anti-virus thread 150 is processed after the audio thread 110 and the video thread 130.

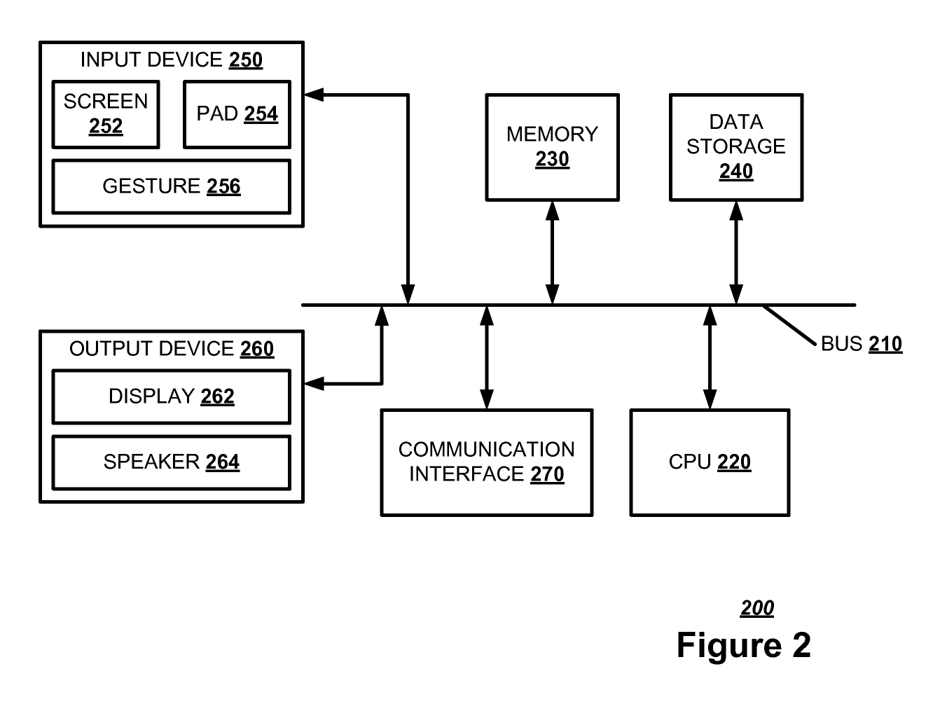

FIG. 2 illustrates a block diagram of an exemplary computing device 200 that may use a processing system. The computing device 200 may combine one or more of hardware, software, firmware, distributed architecture, and system-on-a-chip technology to implement the processing system. The computing device 200 may include a bus 210, a central processing unit (CPU) 220, a memory 230, a data storage 240, an input device 250, an output device 260, and a communication interface 270. The bus 210, or other component interconnection, may permit communication among the components of the computing device 200.

The central processing unit 220 may include at least one conventional processor or microprocessor that interprets and executes a set of instructions. The memory 230 may be a random access memory (RAM) or another type of dynamic data storage that stores information and instructions for execution by the central processing unit 220. The memory 230 may also store temporary variables or other intermediate information used during execution of instructions by the central processing unit 220. The data storage 240 may include a conventional ROM device or another type of static data storage that stores static information and instructions for the central processing unit 220. The data storage 240 may include any type of tangible machine-readable medium, such as, for example, magnetic or optical recording media, such as a digital video disk, and its corresponding drive. A tangible machine-readable medium is a physical medium storing machine-readable code or instructions, as opposed to a signal. Having instructions stored on computer-readable media as described herein is distinguishable from having instructions propagated or transmitted, as the propagation transfers the instructions, versus stores the instructions such as can occur with a computer-readable medium having instructions stored thereon. Therefore, unless otherwise noted, references to computer-readable media/medium having instructions stored thereon, in this or an analogous form, references tangible media on which data may be stored or retained. The data storage 240 may store a set of instructions detailing a method that when executed by one or more processors cause the one or more processors to perform the method. The data storage 240 may also be a database or a database interface for storing thread profiles.

The input device 250 may include one or more conventional mechanisms that permit a user to input information to the computing device 200, such as a keyboard, a mouse, a voice recognition device, a microphone, a headset, a touch screen 252, a touch pad 254, a gesture recognition device 256, etc. The output device 260 may include one or more conventional mechanisms that output information to the user, including a display screen 262, a printer, one or more speakers 264, a headset, a vibrator, or a medium, such as a memory, or a magnetic or optical disk and a corresponding disk drive. The communication interface 270 may include any transceiver-like mechanism that enables computing device 200 to communicate with other devices or networks. The communication interface 270 may include a network interface or a transceiver interface. The communication interface 270 may be a wireless, wired, or optical interface.

The computing device 200 may perform such functions in response to central processing unit 220 executing sequences of instructions contained in a computer-readable medium, such as, for example, the memory 230, a magnetic disk, or an optical disk. Such instructions may be read into the memory 230 from another computer-readable medium, such as the data storage 240, or from a separate device via the communication interface 260.

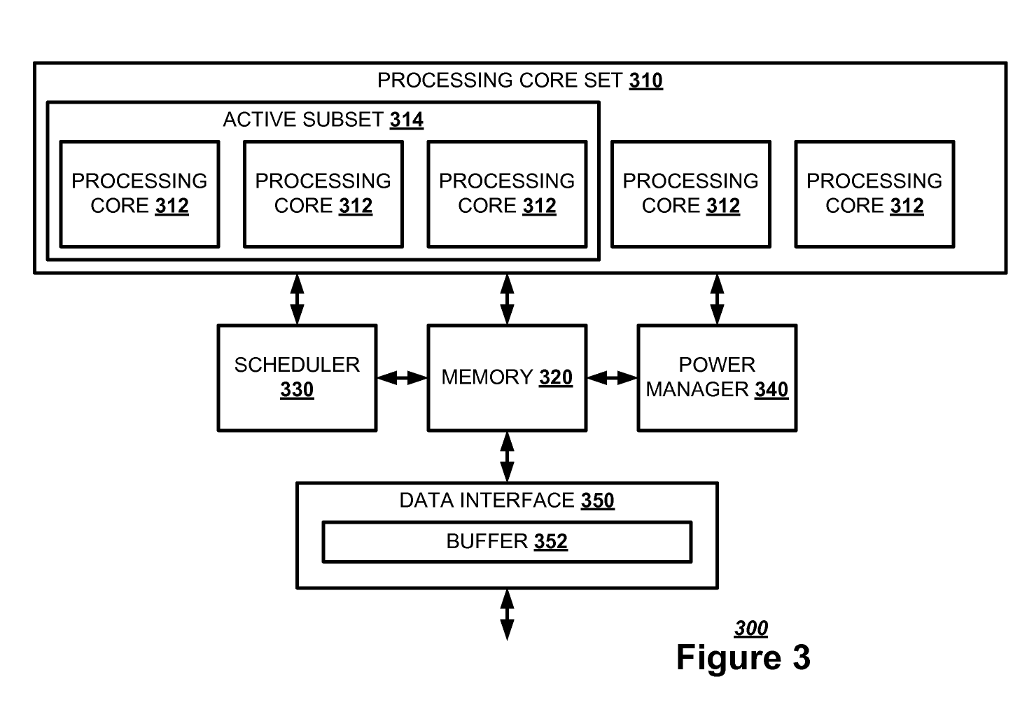

FIG. 3 illustrates, in a block diagram, one example of a processing system 300 that may act as a central processing unit, such as central processing unit 220. The processing system 300 has a processing core set 310 of one or more processing cores 312. A processing core 312 may execute one or more processing threads based on a processing schedule.

A memory 320 may associate a set of one or more scheduling parameters, such as a scheduling priority or a scheduling deadline, with a processing thread. The scheduling priority identifies which processing thread is to receive the preferential allocation of the processing power in relation to a different processing thread. The scheduling deadline indicates the time that a processing thread milestone is to be accomplished. Further, the memory 320 may associate a processing thread with a thread metadata tag describing a thread classification for the processing thread.

A scheduler 330 may determine which processing cores 312 are processing which processing threads at any given time. The scheduler 330 may set a processing schedule for execution of the processing thread based on a set of scheduling parameters. For example, a scheduling parameter may be a scheduling priority for that processing thread, with processing tasks of a processing thread with a high scheduling priority scheduled more often than the processing tasks of a processing thread with a lower scheduling priority. Alternately, the scheduling parameter may be a scheduling deadline for the processing thread, with a processing core executing more processing tasks for a processing thread having an earlier scheduling deadline than the processing thread having a later scheduling deadline. The scheduler 330 may adjust the scheduling priority based on a time frame in relation to the scheduling deadline. Further, the scheduler 330 may factor both the scheduling priority and the scheduling deadline in selecting between a high performance core and an energy efficient core.

The scheduling priority may be dynamic over time. The scheduler 330 may adjust the scheduling priority based on a time frame. The scheduler 330 may dynamically adjust the scheduling priority based on a deadline proximity to the scheduling deadline for the processing thread. The scheduler 330 may switch the scheduling priority to an alternative scheduling priority after the scheduling deadline for the processing thread has passed. An alternative scheduling priority is a scheduling priority adjusted to reflect that a scheduling deadline has passed. The scheduler 330 may switch back to an elevated scheduling priority as a new scheduling deadline approaches.

A power manager 340 may determine which processing cores are active at any given time to conserve power consumption by the processing core set 310. Generally, the fewer processing cores 312 active at a given time, the less power consumed by the processing core set 310. The active processing cores 312 in a processing core set 310 may be referred to as an active processing core subset 314. The power manager 340 may select an active processing core subset 314 from a processing core set 310 and set processing frequencies for each processing core of the active processing core subset 314 based on a scheduling deadline for the processing thread. The power manager 340 may adjust the active processing core subset 314 size and processing frequencies for each processing core of the active processing core subset 314 based on the scheduling deadline for the processing thread. As the scheduling deadline approaches, the power manager may increase the number of processing cores included in the active processing core subset 314 to handle processing tasks in time to meet the scheduling deadline. The power manager 340 may activate the active processing core subset 314 from a processing core set 310 containing the processing core executing a processing thread.

The memory 320 may associate the processing thread with a thread metadata tag describing a thread classification for the processing thread. The scheduler 330 may develop a thread profile for the processing thread based on the thread metadata tag. The thread profile may describe a processing schedule optimized for a processing core to efficiently execute a processing thread. The processing system 300 may have a data interface 350 configured to transfer the thread profile between the scheduler and a data storage, such as data storage 240, to store the thread profile. The scheduler 330 may factor a device form into a thread profile for the processing thread. The device form describes the physical architecture of the processing system 300. The scheduler 330 may set the scheduling priority based on the thread profile.

For a processing thread that produces data, the processing system 300 may output data via the data interface 350. The data interface 350 may have an interface buffer 352 for the orderly transfer of data. The scheduler 330 may set an output data block size based on the thread profile optimized to fit within the interface buffer 352 of the data interface 350. The scheduler 330 may determine a scheduling deadline for the processing thread based on the interface buffer 352. For example, the scheduling deadline may be based on the amount of time to fill up the interface buffer 352.

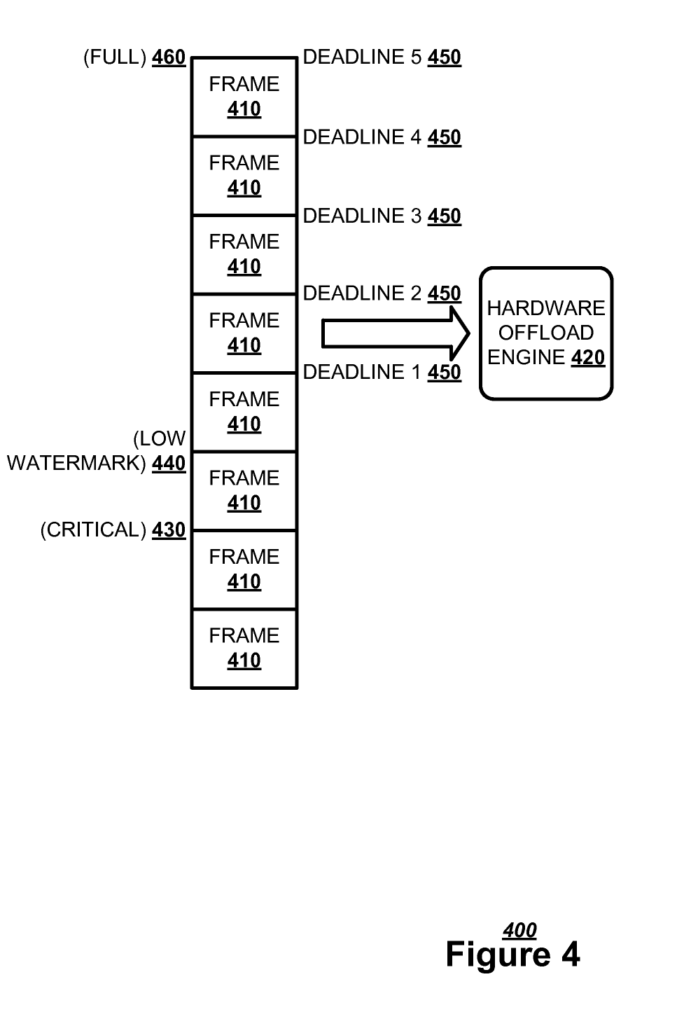

A data output queue may be maintained on the processing system as an interface buffer or may be maintained on a device connected to the processing system. FIG. 4 illustrates, in a block diagram, one example of a data output queue 400. The data output queue 400 may be divided into one or more frames 410 representing a block of an output data block size. A hardware offload engine 420 may send the output data one frame 410 at a time to an output device.

The data output queue 400 may have a critical watermark 430 indicating the minimum number of frames 410 to be present in the data output queue 400 so that performance is not affected. A low watermark 440 may represent one frame beyond the critical watermark 430, warning that a glitch is imminent. Each frame 410 beyond the low watermark 440 may represent a scheduling deadline 450, indicating that the scheduler may downgrade the scheduling priority for that thread until such time as the hardware offload engine 420 has consumed a frame 410 from the data output queue 400. A full watermark 460 may indicate that the data output queue 400 is full, and that the processing core may execute a different processing thread until the hardware offload engine 420 has consumed the data.

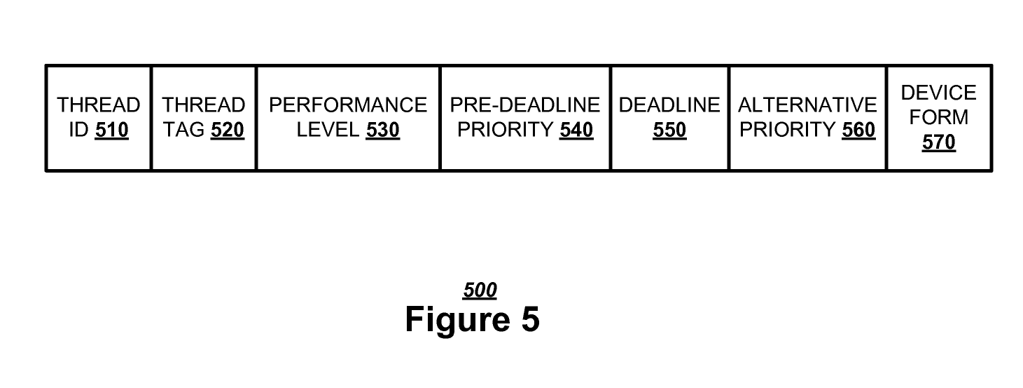

The scheduler may optimize the output data block size based on the thread profile. Further, the power manager may use the thread profile to implement the processing schedule to optimize power usage. FIG. 5 illustrates, in a block diagram, one example of a thread profile 500. If the thread profile 500 is specific to an individual thread, the thread profile 500 may have a thread identifier 510 identifying the processing thread associated with the thread profile 500. The thread profile 500 may have a thread metadata tag 520 describing a thread classification for the processing thread. The thread profile 500 may have different profile data based on a performance level 530 of the processing system, such as a default thread profile and a low-power thread profile. The thread profile 500 may have a pre-deadline scheduling priority 540 for the processing thread. The thread profile 500 may have a scheduling deadline 550 for the processing thread. The scheduling deadline 550 may be in absolute time or may be relative to the start time of the processing thread. The thread profile 500 may have an alternative scheduling priority 560 indicating a scheduling priority after the scheduling deadline 550 has passed. The thread profile 500 may have multiple scheduling deadlines 550 with multiple alternative scheduling priorities 560. The thread profile 500 may have a device form 570 describing the form factor of the computing device.

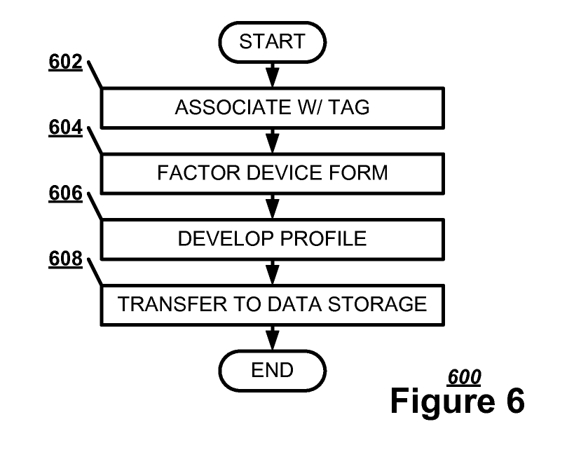

FIG. 6 illustrates, in a flowchart, one example of a method 600 of developing a thread profile. A memory, such as memory 320, may associate a processing thread with a thread metadata tag describing a thread classification for the processing thread (Block 602). A scheduler, such as scheduler 330, may factor a device form into a thread profile for the processing thread (Block 604). A scheduler may develop the thread profile for the processing thread based on the thread metadata tag describing a thread classification for the processing thread (Block 606). A data interface, such as data interface 350, may transfer the thread profile between the scheduler and a data storage (Block 608).

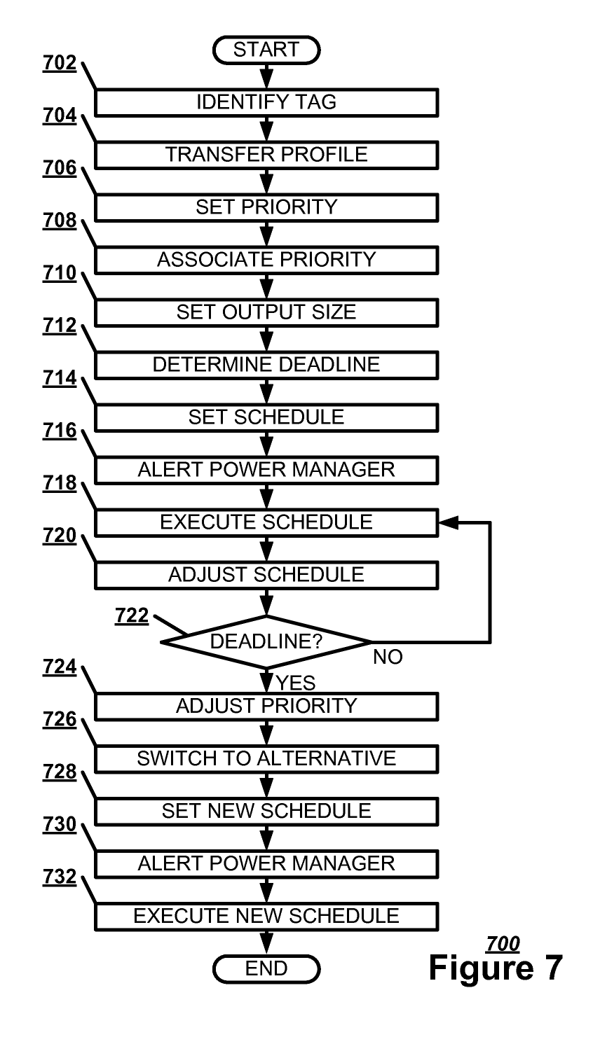

FIG. 7 illustrates, in a flowchart, one example of a method 700 of scheduling a processing thread. A scheduler, such as scheduler 330, may identify thread metadata tag associated with the processing thread (Block 702). A data interface, such as data interface 350, may transfer the thread profile between a data storage and the scheduler (Block 704). The scheduler may set a scheduling priority for the processing thread based on the thread profile (Block 706). A memory, such as memory 320, may associate the scheduling priority with a processing thread (Block 708). The scheduler may set an output data block size based on the thread profile (Block 710). The scheduler may determine a scheduling deadline for the processing thread based on an interface buffer (Block 712). The scheduler may set a processing schedule for execution of the processing thread based on a scheduling parameter set including the scheduling priority and the scheduling deadline for the processing thread (Block 714). The scheduler may alert a power manager, such as power manager 340, as to the processing schedule (Block 716). The scheduler may execute the processing schedule for the processing thread (Block 718). The scheduler may dynamically adjust the processing schedule for the processing thread based on a deadline proximity to a scheduling deadline (Block 720). If the processing system has passed the scheduling deadline (Block 722), the scheduler may adjust the scheduling priority based on a time frame, such as the scheduling deadline for the processing thread (Block 724). The scheduler may switch the scheduling priority to an alternative scheduling priority after the scheduling for the processing thread (Block 726). The scheduler may set a new processing schedule for execution of the processing thread based on the scheduling priority and the scheduling deadline for the processing thread (Block 728). The scheduler may alert the power manager as to the new processing schedule (Block 730). The scheduler may execute the new processing schedule for the processing thread (Block 732).

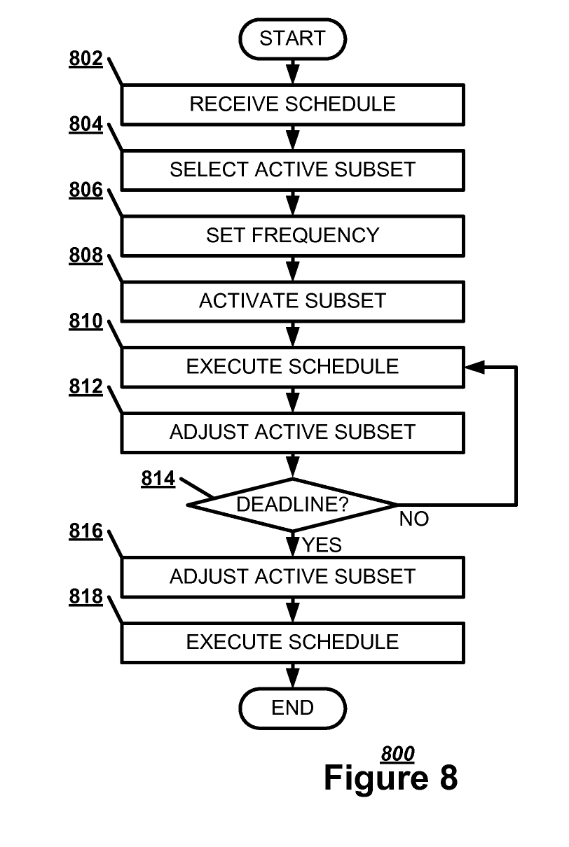

FIG. 8 illustrates, in a flowchart, one example of a method 800 of managing a processing core set. A power manager, such as power manager 340, may receive a processing schedule for a processing thread from a scheduler (Block 802). The power manager may select an active processing core subset from a processing core set based on a scheduling parameter set that includes a scheduling deadline and a scheduling priority for the processing thread (Block 804). The power manager may set one or more processing frequencies for each processing core of the active processing core subset based on a scheduling deadline for the processing thread (Block 806). The power manager may activate the active processing core subset (Block 808). The power manager may execute the processing schedule for the processing thread based on the scheduling parameter set using the active processing core subset (Block 810). The power manager may dynamically adjust the active processing core subset size and the processing frequencies for the active processing core subset based on the deadline proximity of the scheduling deadline (Block 812). If the processing system has passed the scheduling deadline (Block 814), the power manager may adjust the active processing core subset size and the processing frequencies for the active processing core subset based on the deadline proximity of the scheduling deadline (Block 816). The power manager may execute the processing schedule for the processing thread using the new active processing core subset and processing frequencies (Block 818).

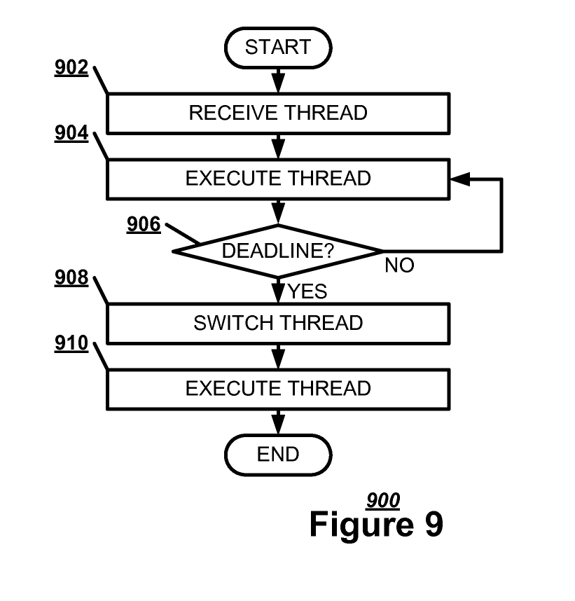

FIG. 9 illustrates, in a flowchart, one example of a method 900 of processing a processing thread. A processing core of an active processing core subset, such as processing core 312, may receive a processing thread for processing (Block 902). The processing core may execute a processing thread task of the processing thread based on a processing schedule (Block 904). If the processing system has passed a scheduling deadline (Block 906), the processing core may switch to a different processing thread (Block 908). The processing core may execute a processing thread task of the new processing thread based on a processing schedule (Block 910).

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Examples within the scope of the present invention may also include computer-readable storage media for carrying or having computer-executable instructions or data structures stored thereon. Such computer-readable storage media may be any available media that can be accessed by a general purpose or special purpose computer. By way of example, and not limitation, such computer-readable storage media can comprise RAM, ROM, EEPROM, CD-ROM or other optical disk storage, magnetic disk storage or other magnetic data storages, or any other medium which can be used to carry or store desired program code means in the form of computer-executable instructions or data structures. Combinations of the above should also be included within the scope of the computer-readable storage media.

Examples may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described examples are part of the scope of the disclosure. For example, the principles of the disclosure may be applied to each individual user where each user may individually deploy such a system. This enables each user to utilize the benefits of the disclosure even if any one of a large number of possible applications do not use the functionality described herein. Multiple instances of electronic devices each may process the content in various possible ways. Implementations are not necessarily in one system used by all end users. Accordingly, the appended claims and their legal equivalents should only define the invention, rather than any specific examples given.

We claim:

1. A processing system, comprising:
a memory configured to associate a scheduling priority with a processing thread;
a scheduler configured to adjust the scheduling priority based on a time frame and setting a processing schedule for execution of the processing thread based on a scheduling parameter set including the scheduling priority; and
at least one processing core configured to execute a processing thread task of the processing thread based on the processing schedule.

2. The processing system of claim 1, wherein the scheduling parameter set includes a scheduling deadline for the processing thread.

3. The processing system of claim 1, wherein the scheduler is configured to dynamically adjust the processing schedule for the processing thread based on a deadline proximity to a scheduling deadline.

4. The processing system of claim 1, wherein the scheduler is further configured to switch the scheduling priority to an alternative scheduling priority after a scheduling deadline for the processing thread.

5. The processing system of claim 1, wherein the scheduler is further configured to determine a scheduling deadline for the processing thread based on an interface buffer.

6. The processing system of claim 1, wherein the memory is further configured to associate the processing thread with a thread metadata tag describing a thread classification for the processing thread.

7. The processing system of claim 1, wherein the scheduler is further configured to develop a thread profile for the processing thread based on a thread metadata tag describing a thread classification for the processing thread.

8. The processing system of claim 1, wherein the scheduler is further configured to factor a device form into a thread profile for the processing thread.

9. The processing system of claim 1, further comprising:
a data interface configured to transfer a thread profile between the scheduler and a data storage.

10. The processing system of claim 1, wherein the scheduler is configured to set the scheduling priority based on a thread profile.

11. The processing system of claim 1, wherein the scheduler is configured to set an output data block size based on a thread profile.

12. The processing system of claim 1, further comprising:
a power manager configured to select an active processing core subset having the at least one processing core from a processing core set based on a scheduling deadline for the processing thread.

13. The processing system of claim 1, further comprising:
a power manager configured to set a processing frequency for a processing core of an active processing core subset of a processing core set based on a scheduling deadline for the processing thread.

14. A tangible machine-readable medium having a set of instructions detailing a method stored thereon that when executed by one or more processors cause the one or more processors to perform the method, the method comprising:
selecting an active processing core subset from a processing core set based on a scheduling parameter set that includes a scheduling deadline for a processing thread;
activating the active processing core subset;
setting a processing schedule for a processing core of the active processing core subset to execute the processing thread based on the scheduling parameter set; and
executing a processing thread task of the processing thread with the processing core based on the processing schedule.

15. The tangible machine-readable medium of claim 14, wherein the method further comprises:
adjusting a scheduling priority for the processing thread in the scheduling parameter set based on the scheduling deadline.

16. The tangible machine-readable medium of claim 14, wherein the method further comprises:
associating the processing thread with a thread metadata tag describing a thread classification for the processing thread.

17. The tangible machine-readable medium of claim 14, wherein the method further comprises:
developing a thread profile for the processing thread based on a thread metadata tag describing a thread classification for the processing thread.

18. The tangible machine-readable medium of claim 14, wherein the method further comprises:
setting a scheduling priority for the processing thread in the scheduling parameter set based on a thread profile associated with the processing thread.

19. A machine-implemented method, comprising:
associating a processing thread with a thread metadata tag describing a thread classification for the processing thread;
setting a scheduling priority for the processing thread based on a thread profile associated with the thread metadata tag;
setting a processing schedule for execution of the processing thread by at least one processing core based on based on a scheduling parameter set including the scheduling priority; and
executing a processing thread task of the processing thread with the at least one processing core based on the processing schedule.

20. The method of claim 19, further comprising:
adjusting the scheduling priority based on a scheduling deadline for the processing thread.
